(19) United States
(12) Patent Application Publication
(10) Pub. No.: US 2003/0170385 A1
(43) Pub. Date: Sep. 11, 2003

(54) Continuous process for coloring particulate materials

(76) Inventors: Scott P. Thompson, Macedonia, OH (US); Rick D. Stoneking, Ravenna, OH (US)

Correspondence Address: MCDONALD, HOPKINS, BURKE & HABER CO., L.P.A., 2100 BANK ONE CENTER, 600 SUPERIOR AVENUE, E., CLEVELAND, OH, 44114-2653, US

(21) Appl. No.: 10/359,801

(22) Filed: Feb. 6, 2003

Related U.S. Application Data
(63) Continuation of application No. 09/938,890, filed on Aug. 24, 2001.
(60) Provisional application No. 60/227,524, filed on Aug. 24, 2000.

(51) Int. Cl. B05D 7/00

(52) U.S. Cl. 427/212

(57) ABSTRACT

A process for coloring high-volumes of sand, stone, and other particulate material by continuously feeding the non-colored particulate material, one or more colorants, and an adhesive binder into a mixer and continuously mixing these materials. During the mixing process, colored particulate material is continuously being removed and transported away from the process as a colored end product.

### CROSS-REFERENCE TO RELATED APPLICATION

This application is based on and claims priority to U.S. Provisional Application Serial No. 60/227,524, filed on Aug. 24, 2000, the entire disclosure of which is incorporated herein by reference.

### BACKGROUND

Coating particulate material, such as sand, stone, gravel, and other minerals, can increase the commercial value of the particulate material, especially when the coated particulate matter is manufactured in bulk quantities. Such coatings can include pigments in the coating that add esthetic value to the material as well as sealants and other materials that make the particulate matter safer to use.

In the past, coating particulate material has been done in batch processes which, although effective in producing a high-quality end product, is neither efficient nor cost effective for producing large volumes of material. In such processes, large amounts of materials must be mixed together in enormous mixers to produce an economically feasible end product. For example, cement mixers have been used with pigment dispersions that have been further diluted with water at up to a 10:1 ratio of water to the pigment dispersion. After mixing in the batch-mode, the colored sand was typically spread out to a depth of a few inches on a clean surface and allowed to dry for a day or even more.

This is particularly true when coloring particulate material, wherein a pigment and binder must be sufficiently dispersed throughout the particulate material in order to produce a high-quality, evenly-colored product. Thus, not only must a large amount of capital be spent to purchase large enough mixers, but the mixers must be capable of achieving high shear rates and enough kinetic energy to evenly disperse the materials. Furthermore, in a batch process, the mixer must be thoroughly cleaned in between each batch in order to maintain a high-quality end product.

The batch coating of particulate matter also must include an additional period of mixing to ensure complete mixing of the ingredients. Not infrequently, pigments, binders and/or sealers can agglomerate when added to sand, stone, and other minerals. Therefore, batch mixing of these ingredients is often continued for extended periods of time such as 15 minutes or longer after the addition of the ingredients has been completed, to ensure complete mixing and avoiding agglomeration of the ingredients.

Finally, coating particulate matter by batch processing also involves large expenditure of time, space, and energy for drying, since large amounts of material must be dried at the same time.

### SUMMARY OF THE INVENTION

The present invention is an improved process for coating particulate materials through use of a continuous process.

In accordance with the present invention, a particulate material and one or more coating materials are fed into a mixer as continuous feeds. The particulate matter and coating material are then thoroughly mixed in the mixer, while a coated particulate product is continuously removed from the mixer. This process is effective for a variety of particulate materials, especially including sand, stone, gravel and particulate mineral matter.

Because a continuous process is used in the present invention, large volumes of coated particulate material can be produced in a more economical manner than when produced in batch processes. Moreover, it has been found that the extended period of mixing after the ingredients have been combined (“post-combining mixing”), typical of batch mixing processes, can be significantly reduced and in some instances eliminated altogether by using a continuous mixing approach. Furthermore, mixing in a continuous mode allows the coated material to be dried in a steady stream, thereby improving the efficiency of the process even further. The inventive process does not require additional water for diluting the pigment dispersions, as is known in the art. Therefore, drying times and the energy required for the drying process are significantly reduced.

A further advantage of the present invention is that the end product can be tested for quality control and the feed rates for each the materials can be adjusted during the process to maintain quality control. The colored material can either be tested visually, such as by comparison to a desired sample, or by using an instrument, such as a spectrophotometer. If a spectrophotometer is used, e.g., the colors can actually be measured and compared quantitatively against each other and known samples.

It is also an advantage of the present invention in that different colored products can be produced without needing extensive downtime to clean the equipment between producing the two different colored end products.

### BRIEF DESCRIPTION OF THE DRAWINGS

In the accompanying drawings, which are incorporated in and constitute a part of this specification, embodiments of the invention are illustrated, which, together with a general description of the invention given above, and the detailed description given below serve to illustrate the principles of this invention. The illustrated embodiments are not meant to limit the invention in such a way that simple modifications, such as those that could be made by one skilled in the art, are not also within the scope and spirit of the inventive concepts discussed and claimed herein. The present invention may be more readily understood by reference to the drawings wherein:

FIG. 1 shows a schematic of the process for coloring particulate material; and

FIG. 2 shows a schematic of the mixer used in the present inventive process.

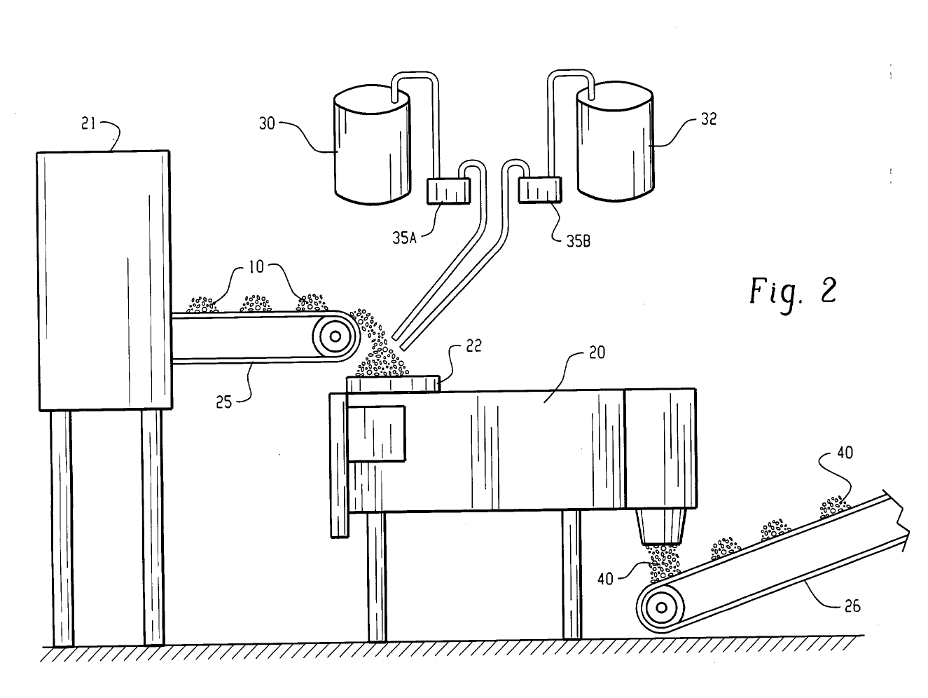

### DETAILED DESCRIPTION

The present invention relates to coating particulate materials in a continuous feed process, and more particularly to a continuous feed process for coloring sand. In the process of the present invention, a particulate material 10, such as sand is fed into a mixer 20 through feed hopper 21 and through feed opening 22, located on top of mixer 20, by conveyor belt 25, while the coating materials, typically one or more colorants 30 and a binder 32, are fed into the mixer 20 by a series of pumps 35a and 35b through feed opening 22. It is generally preferred to mix from about 0.01 to about 1.00 percent by weight of colorant, from about 0.01 to about 1.50 percent by weight of binder, and the balance of the mixture as particulate material—the percents being based on the total weight of the composition. It is even more preferred to mix about 0.20-0.60 weight percent of colorant, about 0.75-1.25 weight percent binder, and the balance of the mixture as particulate material. Again, material 10, colorants 30 and binder 32 enter at the same point, namely feed opening 22. Alternatively or in addition to, colorants 30 and/or binder 32 may be added to the process at a point further downstream (not shown). Alternatively, the particulate material 10 can be fed to mixer 20 by a blower. Mixer 20 churns and mixes the material, thereby providing an even coating on the particulate material 10. The actual mixing rates can be adjustable for each of the material 10, colorants 30 and binder 32. The colored product 40 then exits the mixer 20 through output opening 42 at the bottom of the mixer 20 and then delivered to a drying unit (not shown). The drying unit can be one or more commercially available blower, or fan, units. The blow-drying can take place in a tumbler (not shown). Alternatively, the forced air from the blower units can be heated. Because drying is critical to the adhesion of the sand, it is preferred to use added heat to the blowing air, or that some other mechanism of heating element be introduced, such as outputting the colored sand product 40 onto a conveyor that first exposes the sand to heat lamps before discharge. It will be appreciated by those of skill in the art that other drying units may also work, such as conveyance of colored product 40 under one or more infrared heaters (not shown) with or without blowers, tumblers, and the like, and can be introduced into the process and not depart from the spirit and scope of the present invention. One significant advantage of the present invention is that the process does not require additional water for diluting the pigment dispersions, as is known in the art. Therefore, drying times and the energy required for the drying process are significantly reduced.

The colored product 40 is then delivered to a packaging or storage area by a discharge conveyor 26 or blower. Once to the packaging or storage area, the colored product can be bagged for shipping or dispensed into holding tanks, silos, or large piles for storage.

The feed rates for the particulate material 10, colorant 30 and binder 32 depends on the particular material 10 being colored, the type of colorant 30 being used and the intensity and shade desired.

Essentially any mixer capable of thoroughly mixing solid particulate materials on a continuous basis can be used for mixer 20. Preferred mixers are those which force the mixture to move from an inlet to an outlet along a travel path which is at least three, preferably at least five and even more preferably at least eight, times as long as it is wide. An example is a paddle-type mixer having paddles arranged on a rotating shaft so as to push the mixture from the inlet to the outlet of the travel path. Another example is an auger type mixer. For convenience these mixers are referred to herein as “conveyance mixers.” Especially preferred mixers are conveyance type mixers in which the travel path is arranged at an acute angle with respect to the horizontal plane, preferably in the range of about 30-60 degrees and most preferably at about a 45 degree angle.

Examples of commercially available conveyance mixers which are useful in the present invention are those color mills available from Amerimulch®, a division of ChromaScape, Inc., namely the high volume Mega-Mite™, the medium volume Middie Mite™, or the smaller volume Mini-Mite™ mixers. These are high-shear, paddle-type mixers. An example of an auger style mixer is the Amerimulch 5000 series color mill.

When coating the particulate material with a colorant, it is preferred to use an aqueous dispersion of organic pigments, such as phthalocyanine blues and greens, DNA orange, napthol reds, carbazole violet, quinacridone reds and diarlyide yellows. Other preferred embodiments might include organic pigment dispersions, such as those including one or more of iron oxide, titanium dioxide and chrome oxide green. When choosing pigments, it is preferred to use pigments with high degrees of light stability. Examples of such dispersions include those prepared by CDR Pigments (formerly Alper Dispersions Co.), ChromaScape, Inc. under the Amerimulch brand, Becker Underwood, Creanova, Cardinal Color, Clariant, Magruder, Sun Chemical and Bayer Corporation. The hue and intensity of the colorant can be modified to prepare custom colors by blending the pigments with one another or with a blend of titanium dioxide white pigment. Organic pigment dispersions that are water-based are preferred to solvent-based pigment dispersions because they are less hazardous and more environmentally friendly. Furthermore, dry pigments, such as iron oxides, chromium oxides, and various organic pigments can also be used.

The binder is preferably a water-based self-cross-linking acrylic emulsion, such as Cook Composites and Chemicals' Esicryl 1000 XL™ cross-linked at room temperature, since the cross-linking action improves the water resistance of the colored particulate materials. Other suitable binders include water-based dispersions of non-cross-linking acrylics, such as S.C. Johnson's Jonacryl®, polyurethane, vinyl acetate, vinyl acrylic type polymers, thermosetting resins, such as a two part epoxy system, Cook Composites and Chemicals' Esicryl 749™, and Johnson Wax Company's Jonacryl Acrylic Binder®.

### EXAMPLE 1

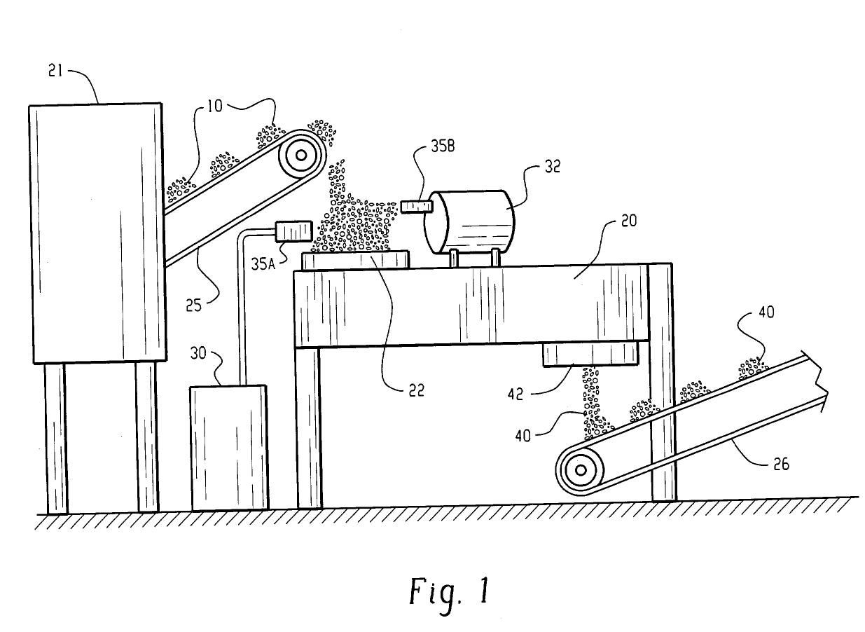

Orange sand was produced using a Middie Mite™ paddle type mixer available from Amerimulch, located at 6409 Granger Road, Independence, Ohio 44131, configured in the manner illustrated in FIG. 1, but with a travel path of the mixer arranged at a 45 degree angle with respect to the horizontal plane. Approximately 98.75% by weight of sand was fed to the inlet of the mixer by a conveyor, 0.25% by weight of DNA orange dispersion (D-0005-182, available from Alper/CDR Pigments, was used) was fed by pump, and 1.00% by weight of Esicryl 1000XL™ was fed by pump as illustrated in FIG. 1. Paddle rotation was carried out at 120 rotations per minute, allowing about 40,000 pounds of coated sand to be produced per hour. As illustrated in FIG. 1, coated sand was discharged from the outlet end of the travel path of the mixer onto a discharge conveyor where it was dried by a method of conveyance through air being blown from an air blower powered by a large, 55-60 horsepower engine. The colored sand product was visually inspected and found to exhibit a uniform, vibrant orange color which remained intact even when the sand was repeatedly handled.

### EXAMPLE 2

Example 1 was repeated using a dispersion of Phthalo blue pigment, code OB15C-888, available from Alper/CDR Pigments, to produce coated sand having a vibrant blue coating.

### EXAMPLE 3

Example 1 was repeated using 0.10% by weight of Quinacridone magenta dispersion, code no. DR122-127, available from Alper/CDR Pigments, mixed with 0.40% by weight of titanium dioxide, and 1.00% by weight of Esicryl 1000XL™ to provide a sand product with a vibrant pink color.

### EXAMPLE 4

Using similar processes as those described in Examples 1-3, limestone particles were colored. The particle sizes were approximately 0.25 to 1.25 inches in diameter, with the majority of the particles approximately 0.75 inches in diameter. A number of the limestone particles broke due to the shear and intensity of the mixing action in the paddle mixer, leaving edges uncolored as the breaks occurred after the exposure to the colorant and binder. This left occasional segments of white, uncolored stone in the mix of otherwise uncoated limestone. This may be overcome with the addition of additional colorant and binder later in the process as mentioned above.

While the present invention has been illustrated by the detailed description, figure, and examples it is not the intention of the applicant to restrict or in any way limit the scope of the appended claims to such details. Additional advantages and modifications will readily appear to those skilled in the art. Therefore, the invention in its broader aspects is not limited to the specific details, representative apparatuses and materials, and illustrative figures shown and described. Accordingly, departures may be made from such details without departing from the spirit or scope of the applicant's general inventive concept.

1. A continuous process for coating particulate material comprising:
continuously feeding a particulate material and a coating material to a mixer;
continuously mixing the particulate material and coating material in the mixer to produce a coated product; and
continuously removing coated product from the mixer.

2. The process of claim 1 wherein mixer is adopted to move a mixture of the particulate material and coating material along a travel path at least three times as long as it is wide.

3. The process of claim 1 wherein the travel path is arranged at an acute angle with respect to the horizontal plane.

4. The process of claim 1 wherein the particulate material is a mineral material.

5. The process of claim 4 wherein the coating includes a colorant.

6. The process of claim 5 wherein the coating includes a binder.

7. The process of claim 5 wherein the colorant is an aqueous dispersion of organic pigments, such as phthalocyanine blues, phthalocyanine greens, DNA orange, napthol reds, quinacridone reds, carbazole violets and diarlyide yellows.

8. The process of claim 1 wherein the coating is a dry pigment.

9. The process of claim 1 wherein the colorant includes titanium oxide.

10. The process of claim 1 wherein the coating includes a water-based acrylic resin capable of self-cross-linking.
